(19) United States
(12) Patent Application Publication
(10) Pub. No.: US 2017/0313314 A1
(43) Pub. Date: Nov. 2, 2017

(54) VEHICLE CONTROL SYSTEM, VEHICLE CONTROL METHOD, AND VEHICLE CONTROL PROGRAM

(71) Applicant: HONDA MOTOR CO., LTD., Tokyo (JP)

(72) Inventors: Naoto Sen, Wako-shi (JP); Masahiko Asakura, Wako-shi (JP)

(73) Assignee: HONDA MOTOR CO., LTD., Tokyo (JP)

(21) Appl. No.: 15/498,005

(22) Filed: Apr. 26, 2017

(30) Foreign Application Priority Data
Apr. 27, 2016 (JP) 2016-089376

(51) Int. Cl. B60W 30/18; B60W 50/08; G05D 1/00; B60W 10/30; B60W 50/14; B60W 40/08

(52) U.S. Cl. CPC B60W 30/18009; B60W 40/08; B60W 50/082; G05D 1/0088; G05D 1/0061; B60W 10/30; B60W 50/14; B60W 2710/20; B60W 2720/10; B60W 2040/0818

(57) ABSTRACT

A vehicle control system includes : a driving controller that executes any one of automated driving and manual driving; an electrically drivable driver's seat of the vehicle; a state detector that detects a state of an occupant seated in the driver's seat; and a seat controller that drives the driver's seat if the state detector detects that the occupant seated in the driver's seat is not in a wakeful state, when a changeover of the driving modes by the driving controller causes a transition from a driving mode in which the occupant seated in the driver's seat does not have a responsibility to monitor the surroundings of the vehicle, to a driving mode in which the occupant has the responsibility to monitor the surroundings.

### CROSS-REFERENC TO RELATED APPLICATION

This application claims priority of Japanese Patent Application No. 2016-089376 filed in Japan on Apr. 27, 2016, the

entire contents of which are incorporated herein by reference.

### Technical Field

The present invention relates to a vehicle control system, a vehicle control method, and a vehicle control program,

### BACKGROUND OF THE INVENTION

In recent years, studies have been made on a technique for automatically performing at least one of speed control and steering control of a vehicle (hereinafter referred to as automated driving). In this context, there is a known technique of controlling a reclining motor of a vehicle to make a reclining angle of a driver's seat, during automated driving mode larger than a reclining angle of the driver's seat during manual driving mode, to notify the driver of a changeover of the driving modes (see International Patent Application Publication No. 2015/011866, for example).

In the conventionally disclosed technique, when switching to a driving mode in which the vehicle occupant has a responsibility to monitor the surroundings, sometimes there is uncertainty in whether the vehicle occupant is in a state where he/she can monitor the surroundings.

### SUMMARY OF THE INVENTION

The present invention has been made in view of the foregoing, and an objective of the invention is to provide a vehicle control system, a vehicle control method, and a vehicle control program that can bring a vehicle occupant seated in a driver's seat of a vehicle into a state where he/she can monitor the surroundings at the time of a changeover of driving modes.

In accordance with a first embodiment of the present invention, a vehicle control system (100) includes: a driving controller (120) that executes one of multiple driving modes having different degrees of automated driving, to control any one of automated driving in which at least one of speed control and steering control of a vehicle is performed automatically, and manual driving in which both of speed control and steering control of the vehicle are performed according to operations of an occupant of the vehicle; an electrically drivable driver's seat (87) of the vehicle; a state detector (172) that detects a state of an occupant seated in the driver's seat; and a seat controller (176) that drives the driver's seat, if the state detector detects that, the occupant seated in the driver's seat is not in a wakeful state, when a changeover of the driving modes by the driving controller causes a transition, from a driving mode in which the occupant seated in the driver's seat does not have a responsibility to monitor the surroundings of the vehicle, to a driving mode in which the occupant has the responsibility to monitor the surroundings.

In accordance with a second embodiment of the invention, the vehicle control system is provided in which the seat controller increases or decreases a reclining angle of the driver's seat in a stepwise manner, if the state detector detects that the occupant seated in the driver's seat is not in a wakeful state, when the transition is performed.

In accordance with a third embodiment of the invention, the vehicle control system described in any one of the first and second embodiments further includes an operation receiver (70) that receives an operation by the occupant, in which, the seat controller makes a change speed of reclining angle of the driver's seat faster than a change speed of reclining angle of the driver's seat based on an instruction received by the operation receiver, if the state detector detects that the occupant seated in the driver's seat is not in a wakeful state, when the transition is performed.

In accordance with a fourth embodiment of the invention, the vehicle control system described in any one of the first to third embodiments is provided in which the seat controller reciprocates the driver's seat between a first direction that enables the occupant to monitor the surroundings of the vehicle, and a second direction opposite to the first direction, if the state detector detects that the occupant seated in the driver's seat is not in a wakeful state, when the transition is performed.

In accordance with a fifth embodiment of the invention, the vehicle control system described in any one of the first to fourth embodiments further includes: an ejection part (93) that ejects misty or vaporized liquid (such as spraying or blowing the liquid toward the driver); and an election controller (178) that ejects the misty or vaporised liquid onto the occupant from the ejection part, when a changeover of the driving modes by the driving controller causes a transition, from a driving mode in which the occupant does not have a responsibility to monitor the surroundings of the vehicle, to a driving mode in which the occupant has the responsibility to monitor the surroundings.

In accordance with a sixth embodiment of the invention, a vehicle control method is provided in which an onboard computer: executes one of multiple driving modes having different degrees of automated driving, to control any one of automated driving in which at least one of speed control and steering control of a vehicle is performed automatically, and manual driving in which both of speed control and steering control of the vehicle are performed according to operations of an occupant of the vehicle; detects a state of an occupant seated in an electrically drivable driver's seat of the vehicle; and drives the driver's seat if it is detected that the occupant seated in the driver's seat is not in a wakeful state, when a changeover of driving modes of the vehicle causes a transition, from a driving mode in which the occupant seated in the driver's seat does not have a responsibility to monitor the surroundings of the vehicle, to a driving mode in which the occupant has the responsibility to monitor the surroundings.

In accordance with a seventh embodiment of the invention, a vehicle control program for causing an onboard computer is provided to execute processing of: executing one of multiple driving modes having different degrees of automated driving, to control any one of automated driving in which at least one of speed control and steering control of a vehicle is performed automatically, and manual driving in which both of speed control and steering control of the vehicle are performed according to operations of an occupant of the vehicle; detecting a state of an occupant seated in an electrically drivable driver's seat of the vehicle; and driving the driver's seat if it is detected that the occupant seated in the driver's seat is not in a wakeful state, when a changeover of driving modes of the vehicle causes a transit ion, from a driving mode in which the occupant seated in the driver's seat does not have a responsibility to monitor the surroundings of the vehicle, to a driving mode in which the occupant has the responsibility to monitor the surroundings. It is understood and well known in the art that such program may be provided in a form of a computer program product having instructions stored in a computer readable media and readable and executable by a computer such as a vehicle control device to execute the instructions.

### Effect of the Invention

According to the first, sixth and seventh embodiments, since the driver's seat is driven at the time of a changeover of driving modes, it is possible to bring the occupant seated in the driver's seat of the vehicle into a state where he/she can monitor the surroundings.

According to the second embodiment, the reclining angle of the driver's seat can be increased or decreased in a stepwise manner, to shake the occupant seated in the driver's seat and prompt wakening. Hence, it is possible to more surely bring the occupant into a state where he/she can monitor the surroundings.

According to the third embodiment, the change speed of reclining angle of the driver's seat can he made faster than normal, to prompt wakening of the occupant seated in the driver's seat. Hence, it is possible to more surely bring the occupant into a state where he/she can monitor the surroundings.

According to the fourth embodiment, the driver's seat can be reciprocated to sway the seated occupant, and prompt wakening of the occupant. Hence, it is possible to more surely bring the occupant into a state where he/she can monitor the surroundings.

According to the fifth embodiment, the misty or vaporized liquid can be ejected onto the occupant seated in the driver's seat, to surprise the occupant, for example, and prompt awakening of the occupant. Hence, it is possible to more surely bring the occupant into a state where he/she can monitor the surroundings.

### BRIEF DESCRIPTION OF THE DRAWINGS

FIG. 1 is a diagram showing components of a vehicle in which a vehicle control system 100 of an embodiment is installed.

FIG. 2 is a functional configuration diagram around the vehicle control system 100.

FIG. 3 is a configuration diagram of an HMI 70.

FIG. 4 is a diagram showing how a vehicle position recognition part 140 recognizes a position of a vehicle M relative to a running lane L1.

FIG. 5 is a diagram showing an example of a behavior plan generated for a certain zone.

FIG. 6 is a diagram showing an example of a configuration of a trajectory generation part 146.

FIG. 7 is a diagram showing an example of trajectory candidates generated by a trajectory candidate generation part 146B.

FIG. 8 is a diagram in which trajectory candidates generated by the trajectory candidate generation part. 146B are expressed in trajectory points K.

FIG. 9 is a diagram showing a lane change-target position TA.

FIG. 10 is a diagram showing a speed generation model assuming that speeds of three surrounding vehicles are constant.

FIG. 11 is a diagram showing an exemplar functional configuration of an HMI controller 170.

FIG. 12 is a diagram showing an example of wakefulness control information 188.

FIG. 13 is a diagram for describing a driving state of a vehicle occupant.

FIG. 14 is a diagram for describing a state of the vehicle occupant inside the vehicle M, when he/she does not have a responsibility to monitor the surroundings.

FIG. 15 is a diagram showing a first example of wakefulness control based on a state detection result.

FIG. 16 is a diagram showing a second example of wakefulness control based on a state detection result.

FIG. 17 is a diagram showing a third example of wakefulness control based on a state detection result.

FIG. 18 is a diagram showing a fourth example of wakefulness control based on a state detection result.

FIG. 19 is a diagram showing an example of mode-specific operablity information 190.

FIG. 20 is a flowchart showing an example of wakefulness control processing.

### DETAILED DESCRIPTION OF THE INVENTION

Hereinbelow, an embodiment of a vehicle control system, a vehicle control method, and a vehicle control program of the present invention will be described with reference to the drawings.

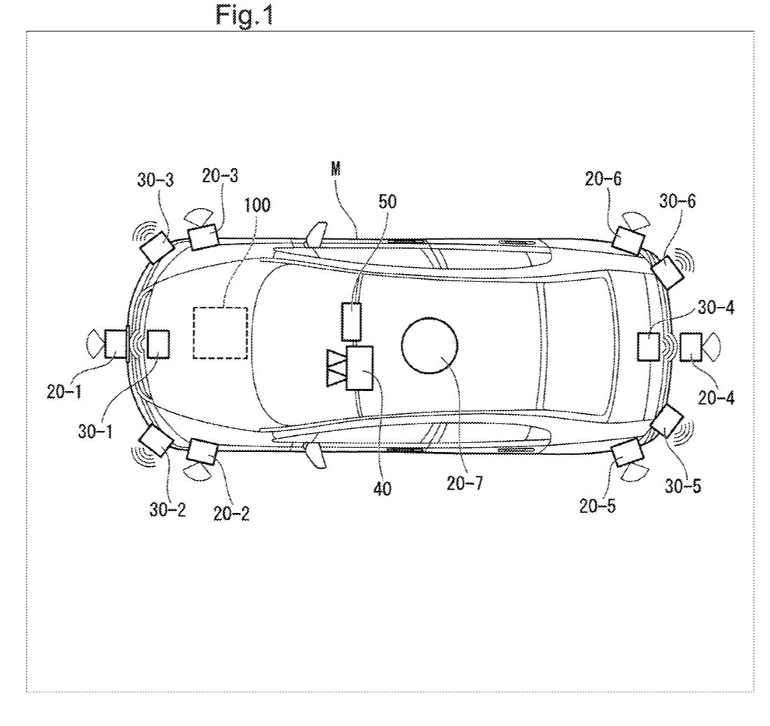

FIG. 1 is a diagram showing components of a vehicle (hereinafter referred to as vehicle M) in which a vehicle control system 100 of the embodiment is installed. The vehicle in which the vehicle control system 100 is installed is a two-wheeled, three-wheeled, or four-wheeled automobile, for example, and includes an automobile that uses an internal combustion engine such as a diesel engine and a gasoline engine as a power source, an electric vehicle that uses a motor as a power source, and a hybrid vehicle that includes both of an internal combustion engine and a motor. An electric vehicle is driven by use of electricity discharged by a battery such as a secondary battery, a hydrogen-fuel cell, a metallic fuel cell, and an alcohol-fuel cell, for example.

As shown in FIG. 1, the vehicle M is equipped with sensors such as finders 20-1 to 20-7, radars 30-1 to 30-6, and a camera (imaging part) 40, a navigation device 50, and the vehicle control system 100.

The finders 20-1 to 20-7 are LIDARs (Light Detection and Ranging, or Laser Imaging Detection and Ranging) that measure light scattered from irradiated light, and measure the distance to the target, for example. For example, the finder 20-1 is attached to a front grille or the like, and the finders 20-2 and 20-3 are attached to side surfaces of the vehicle body, door mirrors, inside headlights, or near side lights, for example. The finder 20-4 is attached to a trunk lid or the like, and the finders 20-5 and 20-6 are attached to side surfaces of the body or inside taillights, for example. The finders 20-1 to 20-6 mentioned above have a detection range of about 150 degrees with respect to the horizontal direction, for example. Meanwhile, the finder 20-7 is attached to a roof or the like. The finder 20-7 has a detection range of 360 degrees with respect to the horizontal direction, for example.

The radars 30-1 and 30-4 are long range millimeter-wave radars that have a longer detection range in the depth direction than the other radars, for example. Meanwhile, the radars 30-2, 30-3, 30-5, and 30-6, are medium range millimeter-wave radars that have a narrower detection range in the depth direction than the radars 30-1 and 30-4.

Hereinafter, the finders 20-1 to 20-7 are simply referred to as “finder 20” when they need not be distinguished from one another, and the radars 30-1 to 30-6 are simply referred to as “radar 30” when they need not be distinguished from one another. The radar 30 detects an object by a FM-CW (Frequency Modulated Continuous Wave) method, for example.

The camera 40 is a digital camera that uses a solid state imaging device such as a CCD (Charge Coupled Device) and a CMOS (Complementary Metal Oxide Semiconductor) for example. The camera 40 is attached to an upper part of a front windshield or on the back of an inside rear view mirror, for example. The camera 40 periodically and repeatedly takes images of the front of the vehicle M, for example. The camera 40 may be a stereoscopic camera including multiple cameras.

Note that the configuration shown in FIG. 1 is merely an example, and the configuration may be partially omitted, or another configuration may be added thereto.

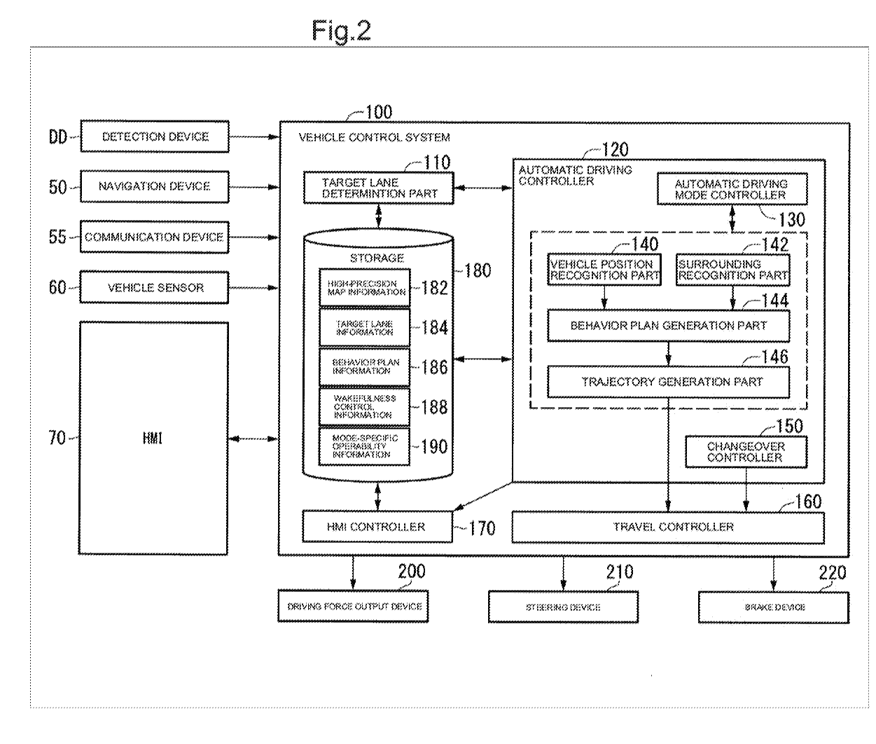

FIG. 2 is a functional configuration diagram around the vehicle control system 100 of the embodiment. The vehicle M is equipped with a detection device DD including the finder 20, the radar 30, and the camera 40, for example, a navigation device (route guidance part, display part) 50, a communication device 55, a vehicle sensor 60, an HMI (Human Machine Interface) 70, the vehicle control system 100, a driving force output device 200, a steering device 210, and a brake device 220. These devices and machinery are mutually connected through a multiplex communication line such as a CAN (Controller Area Network) communication line, a serial communication line, or a wireless communication network, for example. Note that the vehicle control system within the scope of claims does not describe only the “vehicle control system 100,” but may include configurations other than the vehicle control system 100 (e.g., at least one of detection device DD, navigation device 50, communication device 55, vehicle sensor 60, and HMI 70, for example).

The navigation device 50 has a GNSS (Global Navigation Satellite System) receiver, man information (navigation map), a touch panel type display device that functions as a user interface, a speaker, and a microphone, for example. The navigation device 50 estimates the position of the vehicle M by the GNSS receiver, and then calculates a route from that position to a destination specified by the user. The route calculated by the navigation device 50 is provided to a target lane determination part 110 of the vehicle control system 100. An INS (Inertia Navigation System) using output of the vehicle sensor 60 may estimate or compliment the position of the vehicle M. In addition, the navigation device 50 gives guidance on the route to the destination, by sound and navigation display. Note that a configuration for estimating the position of the vehicle M may be provided independently of the navigation device 50. Also, the navigation device 50 may be implemented by a function of a terminal device such as a smartphone and a tablet terminal owned by the user. In this case, information is exchanged between the terminal device and the vehicle control system 100 by wireless or wired communication.

The communication device 55 performs wireless communication using a cellular network, a Wi-Fi network, Bluetooth (registered trademark), or DSRC (Dedicated Short Range Communication), for example.

The vehicle sensor 60 includes a vehicle speed sensor that detects vehicle speed, an acceleration sensor that detects acceleration, a yaw rate sensor that detects the angular velocity around the vertical axis, and a direction sensor that detects the direction of the vehicle M, for example.

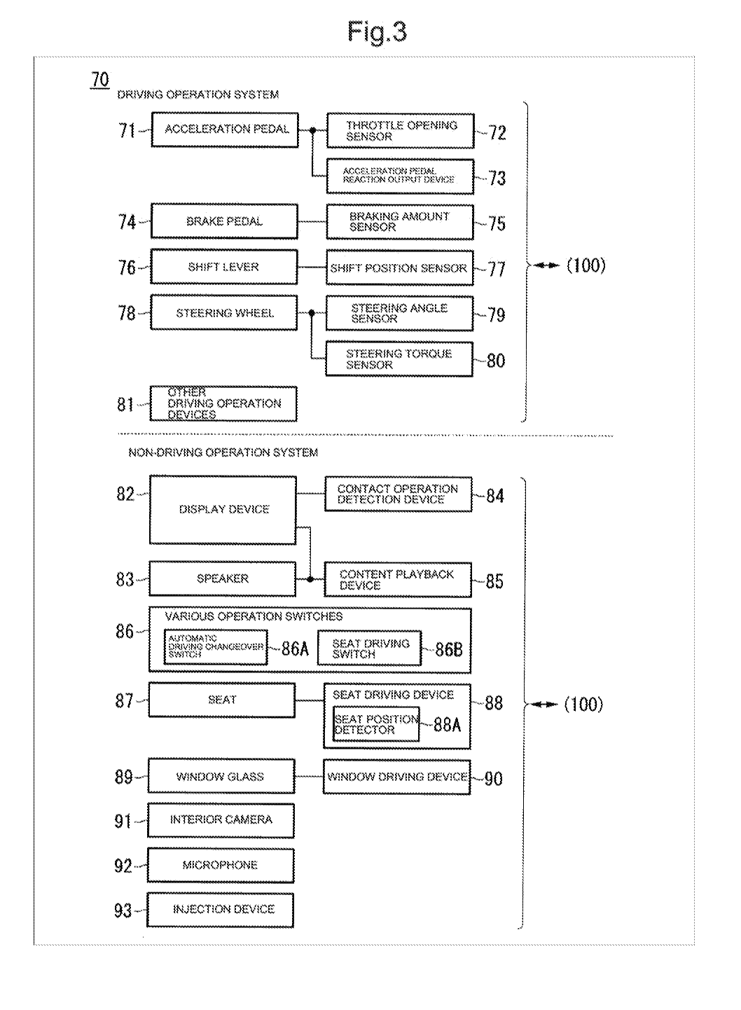

FIG. 3 is a configuration diagram of the HMI 70. The HMI 70 includes configurations of a driving operation system and configurations of a non-driving operation system, for example. The border between these systems is undefined, and a configuration of the driving operation system may include a function of the non-driving operation system (vice versa). Note that a part of the HMI 70 is an example of an “operation receiver” that receives instructions and selections of the vehicle occupant (occupant) of the vehicle, and is an example of an “output part” that outputs information.

The HMI 70 includes, for example, as configurations of the driving operation system: an acceleration pedal 71, a throttle opening sensor 72, and an acceleration pedal reaction output device 73; a brake pedal 74 and a braking amount sensor (or a master pressure sensor, for example) 75; a shift lever 76 and a shift position sensor 77; a steering wheel 78, a steering angle sensor 79, and a steering torque sensor 80; and other driving operation devices 81.

The acceleration pedal 71 is a controller for receiving an acceleration instruction (or an instruction to decelerate by a recovery operation) from the vehicle occupant. The throttle opening sensor 72 detects a pressing amount of the acceleration pedal 71, and outputs a throttle opening signal indicating the pressing amount to the vehicle control system 100. Note that the throttle opening signal may be output directly to the driving force output device 200, the steering device 210, or the brake device 220, instead of to the vehicle control system 100. The same applies to other configurations of the driving operation system described below. The acceleration pedal reaction output device 73 outputs to the acceleration pedal 71 a force (reaction of operation) in a direction opposite to the operation direction, according to an instruction from the vehicle control system 100, for example.

The brake pedal 74 is a controller for receiving a deceleration instruction from the vehicle occupant. The braking amount sensor 75 detects a pressing amount (or pressing force) of the brake pedal 74, and outputs a brake signal indicating the detection result to the vehicle control system 100.

The shift lever 76 is a controller for receiving a shift position change instruction from the vehicle occupant. The shift position sensor 77 detects a shift position instructed by the vehicle occupant, and outputs a shift position signal indicating the detection result to the vehicle control system 100.

The steering wheel 78 is a controller for receiving a turning instruction from the vehicle occupant. The steering angle sensor 79 detects an angle of operation of the steering wheel 78, and outputs a steering angle signal indicating the detection result to the vehicle control system 100. The steering torque sensor 80 detects a torque applied on the steering wheel 78, and outputs a steering torque signal indicating the detection result to the vehicle control system 100.

The other driving operation devices 81 are devices such as a joystick, a button, a dial switch, and a GUI (Graphical User Interface) switch, for example. The other driving operation devices 81 receive an acceleration instruction, a deceleration instruction, a steering instruction and the like, and output them to the vehicle control system 100.

The HMI 70 also includes, for example, as configurations of the non-driving operation system: a display device 82, a speaker 83, a contact operation detection device 84, and a content playback device 85; various operation switches 86; a seat 87 and a seat driving device 88; a window glass 89 and a window driving device 90; an interior camera (imaging part) 91; a microphone (sound acquisition part) 92; and an ejection device (ejection part) 93.

The display device 82 is an LCD (Liquid Crystal Display), an organic EL ( Electro Luminescence) display device, or the like attached to parts of an instrument panel or an arbitrary part opposite to a passenger's seat or a back seat, for example. For example, the display device 82 is a display in front, of a vehicle occupant (hereinafter referred to as “driver” as needed) driving the vehicle M. Also, the display device 82 may be an HUD (Head Up Display) that projects an image on the front windshield or another window, for example. The speaker 83 outputs sound. The contact operation detection device 84 detects a contact position (touch position) on a display screen of the display device 82 when the display device 82 is a touch panel, and outputs it to the vehicle control system 100. Note that the contact operation detection device 84 may be omitted if the display device 82 is not a touch panel.

The display device 82 can output information such as an image output from the aforementioned navigation device 50, and can output information from the vehicle occupant received from the contact operation detection device 84 to the navigation device 50. Note that the display device 82 may have functions similar to those of the aforementioned navigation device 50, for example.

The content playback device 85 includes a DVB (Digital Versatile Disc) playback device, a CD (Compact Disc) playback device, a television receiver, and a device for generating various guidance images, for example. The content playback device 85 may play information stored in a DVD and display an image on the display device 82 or the like, and may play information recorded in an audio CD and output sound from the speaker or the like, for example. Mote that the configuration of some or ail of the above-mentioned display device 82, speaker 83, contact operation detection device 84, and content playback device 85 may be in common with the navigation device 50. In addition, the navigation device 50 may be included in the HMI 70.

The various operation switches 86 are arranged in arbitrary parts inside the vehicle M. The various operation switches 86 include an automated driving changeover switch 86A and a seat driving switch 86B. The automated driving changeover switch 86A is a switch that instructs start (or a later start) and stop of automated driving. The seat driving switch 86B is a switch that instructs start and stop of driving of the seat driving device 88. These switches may be any of a GUI (Graphical User Interface) switch and a mechanical switch. In addition, the various operation switches 86 may include a switch for driving the window driving device 90. Upon receipt of an operation from the vehicle occupant, the various operation switches 86 output a signal of the received operation to the vehicle control system 100.

The seat 87 is a seat on which the vehicle occupant of the vehicle M sits, and is a seat that can be driven electrically. The seat 87 includes the driver's seat on which the occupant sits to drive the vehicle M manually, the passenger's seat next to the driver's seat, and back seats behind the driver's seat and the passenger's seat, for example. Note that “seat 87” includes at least the driver's seat in the following description. The seat-driving device 88 drives a motor or the like according to an operation of the seat driving switch 86B at a predetermined speed (e.g., speed V0), in order to freely change a reclining angle and a position in front, rear, upper, and lower directions of the seat 87, and a yaw angle that indicates a rotation angle of the seat 87, for example. For example, the seat driving device 88 can turn the seat 87 of the driver's seat or the passenger's seat such that it faces the seat 87 of the back seat. Additionally, the seat driving device 88 may tilt a headrest of the seat 87 frontward or rearward.

The seat driving device 88 includes a seat position detector 88A that detects a reclining angle, a position in front, rear, upper, and lower directions, and a yaw angle of the seat 87, and a tilt angle and a position in upper and lower directions of the headrest, for example. The seat driving device 88 outputs information indicating the detection result of the seat position detector 88A to the vehicle control system 100.

The window glass 89 is provided in each door, for example. The window driving device 90 opens and closes the window glass 89.

The interior camera 91 is a digital camera that uses a solid state imaging device such as a CCD and a CMOS. The interior camera 91 is attached to positions such as a rear-view mirror, a steering boss part, and the instrument panel, where it is possible to take an image of at least the head part (including the face) of the vehicle occupant (vehicle occupant performing the driving operation) seated in the driver's seat. The interior camera 91 periodically and repeatedly takes images of the vehicle occupant. The microphone 92 collects interior sounds of the vehicle M. Additionally, the microphone 92 may acquire information on the intonation, volume and the like of the collected sounds.

The ejection device 93 is a device that ejects a misty or vaporized liquid (e.g., mist) or the like onto the face of the vehicle occupant seated in the seat 87 (e.g., driver's seat), for example. The ejection device 93 may move in response to the operation of an air conditioner (air conditioning equipment) of the vehicle M, and eject retained liquid in the form of a mist or gas in the intended direction (the direction of the face of the vehicle occupant), by use of the wind of the air conditioner. Note that the above-mentioned position of the face of the vehicle occupant can be specified by extracting a face image from an image taken by the interior camera 91, on the basis of information on facial features, for example.

Before describing the vehicle control system 100, a description will be given of the driving force output device 200, the steering device 210, and the brake device 220.

The driving force output device 200 outputs a driving force (torque) by which the vehicle travels, to the driving wheels. If the vehicle M is an automobile that uses an internal combustion engine as a power source, for example, the driving force output device 200 includes an engine, a transmission, and an engine ECU (Electronic Control Unit) that controls the engine. If the vehicle M is an electric vehicle that uses a motor as a power source, the driving force output device includes a travel motor and a motor ECU that controls the travel motor. If the vehicle M is a hybrid vehicle, the driving force output device includes an engine, a transmission, an engine ECU, a travel motor, and a motor ECU. When the driving force output device 200 includes only the engine, the engine ECU adjusts the throttle opening of the engine and the shift position, for example, according to information input from a later-mentioned travel controller 160. When the driving force output device 200 includes only the travel motor, the motor ECU adjusts the duty cycle of a PWK signal provided to the travel motor, according to information input from the travel controller 160. When the driving force output device 200 includes the engine and the travel motor, the engine ECO and the motor ECU work together to control the driving force, according to information input from the travel controller 160.

The steering device 210 includes a steering ECU and an electric motor, for example. The electric motor varies the direction of the steering wheel by applying force on a rack and pinion mechanism, for example. The steering ECU drives the electric motor according to information input from the vehicle control system 100 or input, information on the steering angle or steering torque, and thereby varies the direction of the steering wheel.

The brake device 220 is an electric servo brake device including a brake caliper, a cylinder that transmits hydraulic pressure to the brake caliper, an electric motor that generates hydraulic pressure in the cylinder, and a brake controller, for example. The brake controller of the electric servo brake device controls the electric motor according to information input from the travel controller 160, so that a brake torque corresponding to the braking operation can be output to each wheel. The electric servo brake device may include, as a backup, a mechanism that transmits hydraulic pressure generated by operation of the brake pedal to the cylinder, through a master cylinder. Note that the brake device 220 is not limited to the electric servo brake device described above, and may be an electronically controlled hydraulic brake device. The electronically controlled hydraulic brake device controls an actuator according to information input from the travel controller 160, and transmits hydraulic pressure of the master cylinder to the cylinder. Additionally, the brake device 220 may include a regenerative brake driven by a travel motor that may be included in the driving force output device 200.

[Vehicle Control System]

Hereinafter, the vehicle control system 100 will be described. The vehicle control system 100 is implemented by one or more processors, or hardware having the equivalent function, for example. The vehicle control system 100 may configured of an ECU (Electronic Control Unit) in which a processor such as a CPU (Central Processing Unit), a storage device, and a communication interface are connected by an internal bus, or may be a combination of an MPU (Micro-Processing Unit) and other components.

Referring back to FIG. 2, the vehicle control system 100 includes the target lane determination part 110, an automated driving controller (driving controller) 120, the travel controller 160, an HMI controller (interface controller) 170, and a storage 180, for example. The automated driving controller 120 includes an automated driving mode controller 130, a vehicle position recognition part 140, a surrounding recognition part: 142, a behavior plan generation part 144, a trajectory generation part 146, and a changeover controller 150, for example.

Some or all of the target lane determination part 110, each part of the automated driving controller 120, the travel controller 160, and the HMI controller 170 are implemented by executing a program (software) by a processor. Also, some or all of these components may be implemented by hardware such as an LSI (Large Scale Integration) and an ASIC (Application Specific Integrated Circuit), or may be implemented by a combination of software and hardware.

The storage 180 stores information such as high-precision map information 182, target lane information 184, behavior plan information 186, wakefulness control information 188, and mode-specific operability information 190, for example. The storage 180 is implemented by a ROM (Read Only Memory), a RAM (Random Access Memory), an HDD (Hard Disk Drive), a flash memory, or other devices. The program executed by the processor may be previously stored in the storage 180, or may be downloaded from an external device through onboard Internet equipment or the like. Also, the program may be installed into the storage 180, by attaching a portable storage medium storing the program to an unillustrated drive device. Additionally, a computer (onboard computer) of the vehicle control system 100 may be dispersed to multiple computers.

The target lane determination part 110 is implemented by an MPU, for example. The target lane determination part 110 splits a route provided by the navigation device 50 into multiple blocks (e.g., splits the route every 100[m] in the traveling direction of the vehicle), and determines a target lane for each block by referring to the high-precision map information 182.

In addition, the target lane determination part 110 determines, for each of the above-mentioned blocks, for example, whether or not automated driving can be performed along the route provided by the navigation device 50. For example, the target lane determination part 110 determines, under control of the automated driving controller 120, what number lane from the left to travel, for example, in a zone where the vehicle M can be driven in automated driving mode. The zone where the vehicle can be driven in automated driving mode can be set on the basis of entrances and exits (ramp, interchange) of a highway, positions of toll gates or the like, and the shape of the road (a straight line not shorter than a predetermined distance), for example. The zone where the vehicle can be driven in automated driving mode is a zone where the vehicle travels on a highway, for example, but is not limited to this.

Note that when a zone where automated driving is possible is not shorter than a predetermined distance, for example, the target lane determination part 110 may display the zone as a candidate zone for which the vehicle occupant can determine whether or not to perform automated driving. This can remove the burden on the vehicle occupant, to check the necessity of automated driving for zones where automated driving is possible only for a short distance. Note that the above processing may be performed by any of the target lane determination part 110 and the navigation device 50.

When there is a branching part, a merging part, or the like in the traveling rout, for example, the target lane determination part 110 determines a target lane so that the vehicle M can take a rational traveling route to proceed to the branch destination. The target lane determined by the target lane determination part 110 is stored in the storage 180 as the target lane information 184.

The high-precision map information 182 is map information having higher precision than the navigation map included in the navigation device 50. For example, the high-precision map information 182 includes information on the center of a lane, information on the border of lanes, and the like. In addition, the high-precision map information 182 may include road information, traffic regulation information, address information (address, postal code), facility information, and telephone number information, for example. Road information includes information indicating types of roads such as a highway, a toll road, a national road, and a prefectural road, and information such as the number of lanes in a road, the width of each lane, the grade of a road, the position (three-dimensional coordinate including longitude, latitude, and height) of a road, the curvature of a curve of a lane, positions of merging and branching points in a lane, and signs or the like on a road. Traffic regulation information may include information such as blockage of a lane due to construction, traffic accident, or congestion, for example.

Additionally, upon acquisition of information indicating a traveling route candidate from the aforementioned navigation device 50, the target lane determination part 110 refers to the high-precision map information 182 or the like, to acquire information on the zone in which to travel in automated driving mode from the automated driving controller 120, and outputs the acquired information to the navigation device 50. Also, when the route to destination and the automated driving zone are defined by the navigation device 50, the target lane determination part 110 generates the target lane Information 184 corresponding to the route and automated driving zone, and stores it in the storage 180.

The automated driving controller 120 performs one of multiple driving modes having different degrees of automated driving, for example, to automatically perform at least one of speed control and steering control of the automotive vehicle. Note that speed control is control related to speed adjustment of the vehicle M, for example, and speed adjustment includes one or both of acceleration and deceleration. Additionally, the automated driving controller 120 controls manual driving in which both of speed control and steering control of the vehicle M are performed on the basis of operations by the vehicle occupant, of the vehicle M, according to the operations or the like received by the operation receiver of the HMI 70, for example.

The automated driving mode controller 130 determines the automated driving mode performed by the automated driving controller 120. The automated driving modes of the embodiment include the following modes. Mote that the following are merely an example, and the number of automated driving modes may be determined arbitrarily.

[Mode A]

Mode A is a mode having the highest degree of automated driving. When mode A is executed, all vehicle control including complex merge control is performed automatically, and therefore the vehicle occupant need not monitor the surroundings or state of the vehicle M (occupant has no surrounding-monitoring responsibility).

[Mode B]

Mode B is a mode having the next highest degree of automated driving after Mode A. When Mode B is executed, basically all vehicle control is performed automatically, but the vehicle occupant is sometimes expected to perform driving operations of the vehicle M depending on the situation. Hence, the vehicle occupant is required to monitor the surroundings and state of the vehicle M (occupant has surrounding-monitoring responsibility).

[Mode C]

Mode C is a mode having the next highest degree of automated driving after Mode B. Mien Mode C is executed, the vehicle occupant is required to perform a confirmation operation of the HMI 70, depending on the situation. In Mode C, when the vehicle occupant is notified of a lane change timing and performs an operation to instruct the lane change to the HMI 70, for example, the lane is changed automatically. Hence, the vehicle occupant is required to monitor the surroundings and state of the vehicle M (occupant has surrounding-monitoring responsibility). Note that in the embodiment, a mode having the lowest degree of automated driving may be a manual driving mode in which automated driving is not performed, and both of speed control and steering control of the vehicle M are performed according to operations by the vehicle occupant of the vehicle M. In the case of the manual driving mode, the driver has a responsibility to monitor the surroundings, as a matter of course.

The automated driving mode controller 130 determines the automated driving mode on the basis of an operation of the HMI 70 by the vehicle occupant, an event determined by the behavior plan generation part 144, and a traveling mode determined by the trajectory generation part 146, for example. The automated driving mode is notified to the HMI controller 170. Also, limits depending on the performance of the detection device DD of the vehicle M may be set for the automated driving modes. For example, Mode A may be omitted if performance of the detection device DD is low. In any mode, it is possible to switch to the manual driving mode (override) by an operation of a configuration of the driving operation system of the HMI 70.

The vehicle position recognition part 140 recognizes a lane that the vehicle M is traveling (running lane) and a position of the vehicle M relative to the running lane, on the basis of the high-precision map information 182 stored in the storage 180, and information input from the finder 20, the radar 30, the camera 40, the navigation device 50, or the vehicle sensor 60.

The vehicle position recognition part 140 recognizes the running lane by comparing a pattern of road surface markings (e.g., arrangement of solid lines and broken lines) recognized from the high-precision map information 182, and a pattern of road surface markings surrounding the vehicle M recognized from an image taken by the camera 40, for example. This recognition may take into account, a position of the vehicle M acquired from the navigation device 50, and an INS processing result.

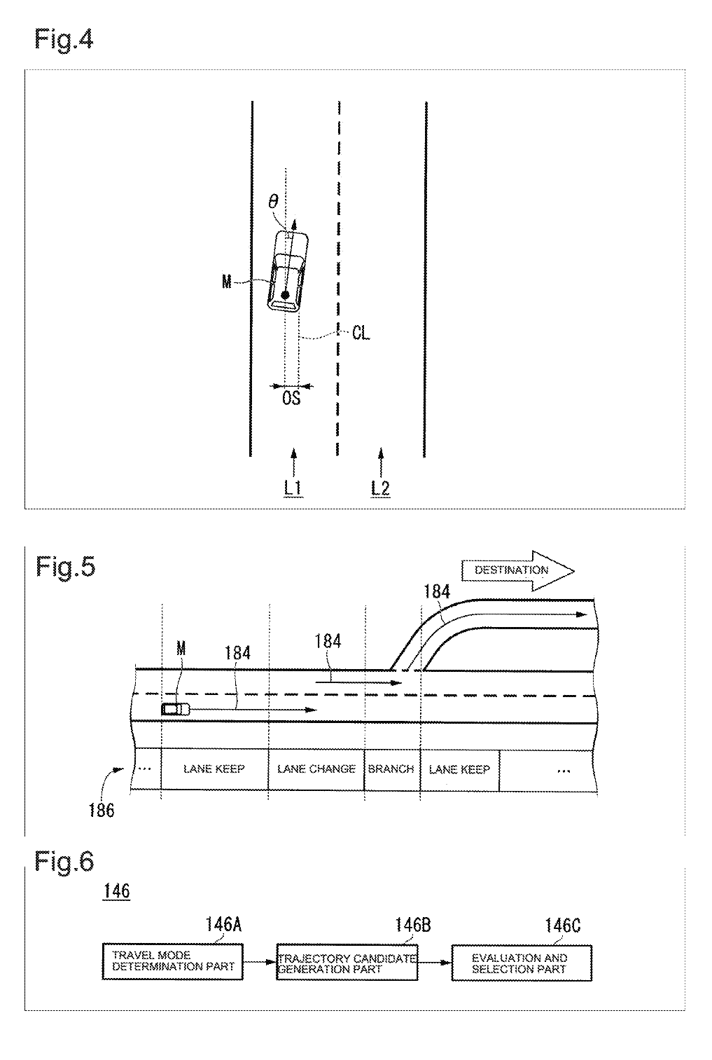

FIG. 4 is a diagram showing how a vehicle position recognition part 140 recognizes a position of the vehicle M relative to a running lane L1. The vehicle position recognition part 140 recognizes a deviation OS of a reference point (e.g., center of gravity) of the vehicle M from a running lane center CL, and an angle θ between the traveling direction of the vehicle M and the running lane center CL, as the position of the vehicle M relative to the running lane L1. Note that the vehicle position recognition part 140 may instead recognize a position of the reference point of the vehicle M relative to one of side ends of the running lane L1, for example, as the position of the vehicle M relative to the running lane. The relative position of the vehicle M recognized by the vehicle position recognition part 140 is provided to the target lane determination part 110.

The surrounding recognition part 142 recognizes states such as positions, speed, and acceleration of surrounding vehicles, on the basis of information input from the finder 20, the radar 30, and the camera 40, for example. Surrounding vehicles are vehicles traveling near the vehicle M, for example, and are vehicles that travel in the same direction as the vehicle M. A position of a surrounding vehicle may be represented by a representative point such as the center of gravity or a corner of this other vehicle, for example, or may be represented by an area indicated by an outline of this other vehicle. The “state” of a surrounding vehicle may include acceleration of the surrounding vehicle, or whether or not the vehicle is changing lanes (or intends to change lines), which is understood from information of the various equipment described above. In addition to the surrounding vehicles, the surrounding recognition part 142 may also recognize positions of a guardrail, a telephone pole, a parked vehicle, a pedestrian, a fallen object, a railroad crossing, a traffic light, a sign set up near a construction site or the like, and other objects.

The behavior plan generation part 144 sets a start point of automated driving and/or a destination of automated driving. The start point of automated driving may be the current position of the vehicle M, or may be a point where the automated driving is instructed. The behavior plan generation part 144 generates a behavior plan of a zone between the start point and the destination of automated driving. Note that the embodiment is not limited to this, and the behavior plan generation part 144 may generate a behavior plan for any zone.

A behavior plan is configured of multiple events to be performed in sequence, for example. Events include: a deceleration event of decelerating the vehicle M; an acceleration event of accelerating the vehicle M; a lane keep event of driving the vehicle M such that it does not move out of the running lane; a lane change event of changing the running lane; a passing event of making the vehicle M pass a front vehicle; a branching event of changing to a desired lane or driving the vehicle M such that it does not move out of the current running lane, at a branching point; a merging event of adjusting the speed of the vehicle M in a merge lane for merging with a main lane, and changing the running lane; and a handover event of transitioning from manual driving mode to automated driving mode at the start point of automated driving, and transitioning from automated driving mode to manual driving mode at the scheduled end point of automated driving, for example.

In a target lane changeover part determined by the target lane determination part 110, the behavior plan generation part 144 sets a lane change event, a branching event, or a merging event. Information indicating the behavior plan generated by the behavior plan generation part 144 is stored in the storage 180 as the behavior plan information 186.

FIG. 5 is a diagram showing an example of a behavior plan generated for a certain zone. As shown in FIG. 5, the behavior plan generation part 144 generates a behavior plan required for the vehicle M to travel in the target lane indicated by the target lane information 184. Note that the behavior plan generation part 144 may dynamically change a behavior plan regardless of the target lane information 184, in response to a change in situation of the vehicle M. For example, the behavior plan generation part 144 changes an event set for a driving zone that the vehicle M is scheduled to travel, if the speed of a surrounding vehicle recognized by the surrounding recognition part 142 exceeds a threshold during travel, or if the moving direction of a surrounding vehicle traveling in a lane next to the lane of the vehicle M turns toward the lane of the vehicle M. For example, when events are set such that a lane change event is to be performed after a lane keep event, and it is found from a recognition result of the surrounding recognition part 142 that a vehicle is moving at a speed not lower than a threshold from the back of a lane change destination lane during the lane keep event, the behavior plan generation part 144 may change the event after the lane keep event from the lane change event to a deceleration event or a lane keep event, for example. As a result, the vehicle control system 100 can enable safe automated driving of the vehicle M, even when a change occurs in the surrounding situation.

FIG. 6 is a diagram showing an example of a configuration of the trajectory generation part 146. The trajectory generation part 146 includes a traveling mode determination part 146A, a trajectory candidate generation part 146B, and an evaluation and selection part 146C, for example.

For example, when performing a lane keep event, the traveling mode determination part 146A determines a traveling mode from among constant-speed travel, tracking travel, low-speed tracking travel, deceleration travel, curve travel, obstacle avoiding travel, and the like. For example, when there is no vehicle in front of the vehicle M, the traveling mode determination part 146A determines to set the traveling mode to constant-speed travel. When tracking a front vehicle, the traveling mode determination part 146A determines to set the traveling mode to tracking travel. In a congested situation, for example, the traveling mode determination part 146A determines to set the traveling mode to low-speed tracking travel. When the surrounding recognition part 142 recognizes deceleration of a front vehicle, or when performing an event such as stop and parking, the traveling mode determination part 146A determines to set the traveling mode to deceleration travel. When the surrounding recognition part 142 recognizes that the vehicle M is approaching a curved road, the traveling mode determination part 146A determines to set the traveling mode to curve travel. When the surrounding recognition part 142 recognizes an obstacle in front of the vehicle M, the traveling mode determination part 146A determines to set the traveling mode to obstacle avoiding travel.

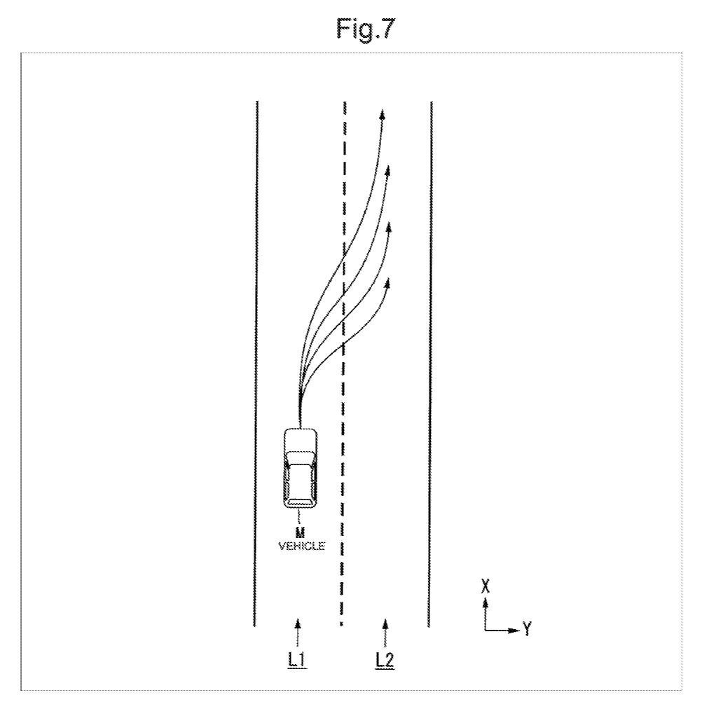

The trajectory candidate generation part 146B generates a trajectory candidate on the basis of the traveling mode determined by the traveling mode determination part 146A. FIG. 7 is a diagram showing an example of trajectory candidates generated by the trajectory candidate generation part 146B. FIG. 7 shows trajectory candidates generated when the vehicle M changes lanes from the lane L1 to a lane L2.

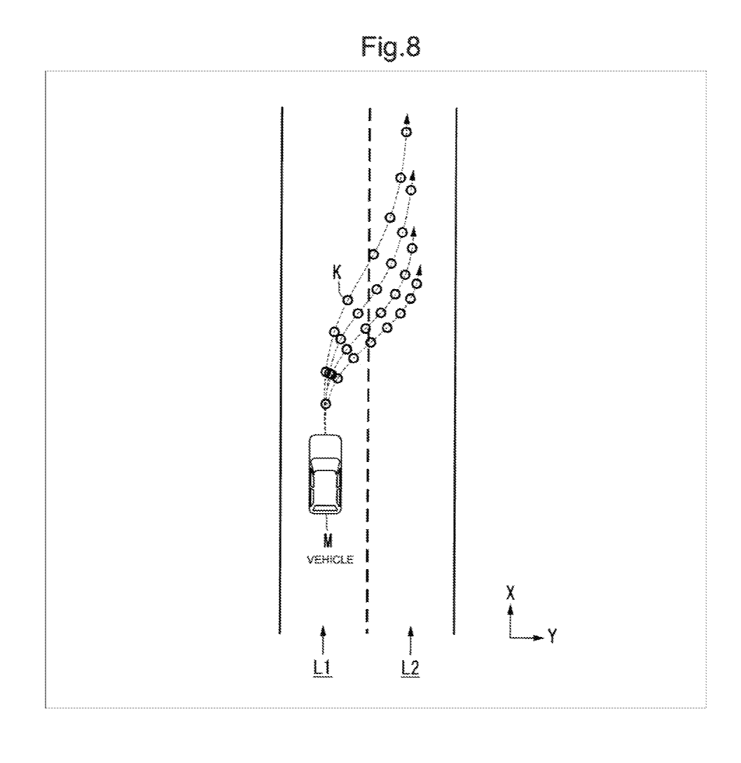

The trajectory candidate generation part 146B determines trajectories such as in FIG. 7 as a group of target positions (trajectory points K) that the reference position (e.g., center of gravity or center of rear wheel axle) of the vehicle M should reach, for each predetermined future time, for example. FIG. 8 is a diagram in which trajectory candidates generated by the trajectory candidate generation part 146B are expressed in the trajectory points K. The wider the intervals between the trajectory points K, the higher the speed of the vehicle M, and the narrower the intervals between the trajectory points K, the lower the speed of the vehicle M. Hence, the trajectory candidate generation part 146B gradually widens the intervals between the trajectory points K to accelerate, and gradually narrows the intervals between the trajectory points K to decelerate.

Since the trajectory points K thus include a velocity component, the trajectory candidate generation part 146B needs to assign a target speed to each of the trajectory points K. The target speed is determined according to the traveling mode determined by the traveling mode determination part 146A.

Here, a description will be given of how to determine a target speed when changing lanes (including branching). The trajectory candidate generation part 146B first sets a lane change-target position (or merge target position). A lane change-target position is set as a position relative to surrounding vehicles, and determines “which of the surrounding vehicles to move in between after changing lanes.” The trajectory candidate generation part 146B determines the target speed when changing lanes, by focusing on three surrounding vehicles based on the lane change-target position.

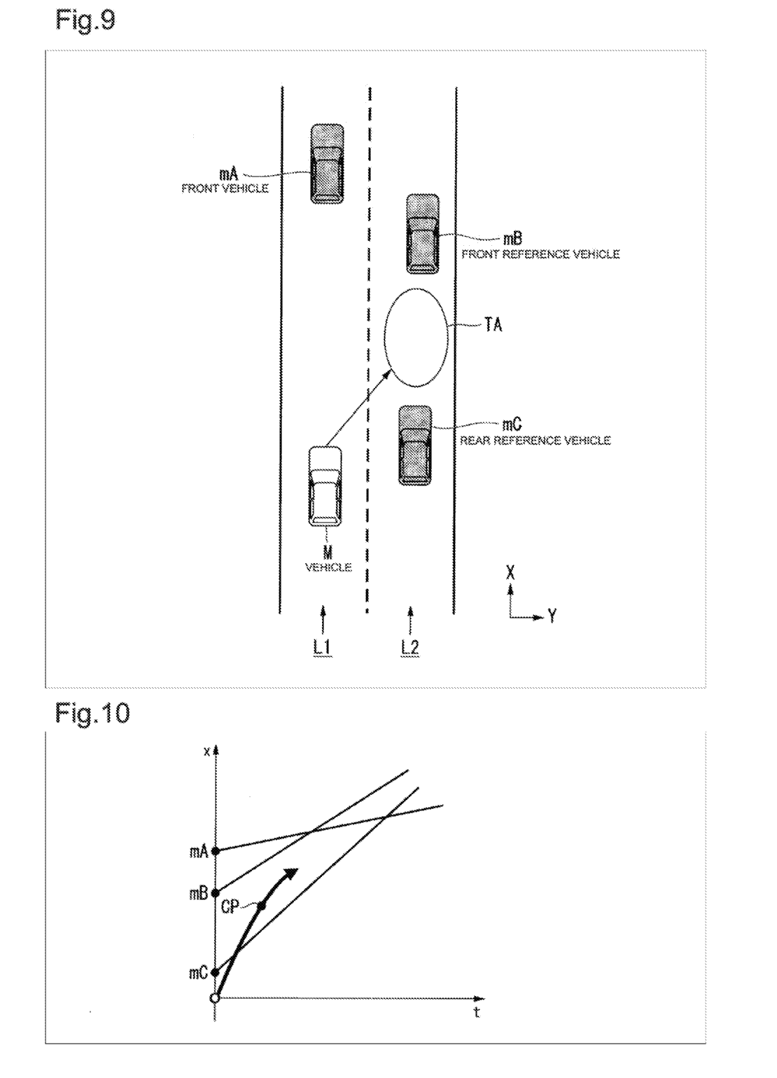

FIG. 9 is a diagram showing a lane change-target position TA. In FIG. 9, L1 indicates the lane of the vehicle M, and L2 indicates the adjacent lane. Here, a surrounding vehicle traveling immediately in front of the vehicle M in the same lane as the vehicle M is defined as a front vehicle mA, a surrounding vehicle traveling immediately in front of the lane change-target position TA is defined as a front reference vehicle mB, and a surrounding vehicle traveling immediately behind the lane change-target position TA is defined as a rear reference vehicle mC. The vehicle M needs to adjust speed to move to the side of the lane change-target position TA, but also needs to avoid catching up with the front vehicle mA at this time. Hence, the trajectory candidate generation part 146B predicts future states of the three surrounding vehicles, and determines the target speed in such a manner as to avoid interference with the surrounding vehicles.

FIG. 10 is a diagram showing a speed generation model assuming that speeds of the three surrounding vehicles are constant. In FIG. 10, straight lines extending from mA, mB, and mC indicate displacement in the traveling direction of the respective surrounding vehicles, assuming that they travel at constant speed. The vehicle M needs to be in between the front reference vehicle mB and the rear reference vehicle mC at point CP when the lane change is completed, and needs to be behind the front vehicle mA before point CP. Under these limitations, the trajectory candidate generation part 146B calculates multiple time-series patterns of target speed before completion of the lane change. Then, the trajectory candidate generation part calculates multiple trajectory candidates as in FIG. 7, by applying the time-series patterns of target speed to a model such as a spline curve. Note that the motion patterns of the three surrounding vehicles are not limited to those at constant speed as in FIG. 10, and the prediction may be made under the assumption of constant acceleration or constant jerk.

The evaluation and selection part 146C evaluates the trajectory candidates generated by the trajectory candidate generation part 146B from two viewpoints of planning and safety, for example, and selects the trajectory to output to the travel controller 160. In terms of planning, for example, a trajectory that closely follows an existing plan (e.g., behavior plan), and has a short overall length is highly evaluated. For example, when a lane change to the right is desired, a trajectory such as first changing lanes to the left and then returning is poorly evaluated. In terms of safety, for example, at each trajectory point, a longer distance between the vehicle M and objects (e.g., surrounding vehicles), and less variation or the like in acceleration and deceleration speed and steering angle are highly evaluated.

The changeover controller 150 switches between the automated driving mode and the manual driving mode, on the basis of a signal inputted from the automated driving changeover switch 86A, for example. The changeover controller 150 switches driving modes on the basis of an acceleration, deceleration, or steering instruction given to the driving operation system of the HMI 70. Also, the changeover controller 150 performs handover control for transitioning from automated driving mode to manual driving mode, near a scheduled end point of automated driving mode set in the behavior plan information 186, for example.

The travel controller 160 controls the driving force output device 200, the steering device 210, and the brake device 220, such that the vehicle M can follow the running trajectory generated (scheduled) by the trajectory generation part 146, according to the scheduled time.

Upon receipt of information on a changeover of driving modes from the automated driving controller 120, the HMI controller 170 controls the HMI 70 and the like according to the input information. For example, if it is detected that the vehicle occupant, seated in the driver's seat is not in a wakeful state, when a changeover of driving modes by the automated driving controller 120 causes a transition from a driving mode in which the vehicle occupant seated in the driver's seat does not have a responsibility to monitor the surroundings of the vehicle M to a driving mode in which the vehicle occupant has the responsibility to monitor the surroundings, the HMI controller 170 performs control to wake the vehicle occupant. Note that waking the vehicle occupant means to bring the vehicle occupant seated in the driver's seat into a state where he/she can drive, for example. To be specific, waking the vehicle occupant means, for example, to wake up the vehicle occupant when he/she had been sleeping with the seat 87 reclined during automated driving of the vehicle M, and to bring the vehicle occupant into a state where he/she can drive the vehicle M manually. However, the embodiment is not limited to this.

FIG. 11 is a diagram showing an exemplar functional configuration of the HMI controller 170. The HMI controller 170 shown in FIG. 11 includes a state detector 172 and a wakefulness controller 174. Also, the wakefulness controller 174 includes a seat controller 176 and an ejection controller 178.

The state detector 172 at least detects a state of the vehicle occupant seated in the seat 87 of the driver's seat of the vehicle M. The state detector 172 may detect a state of a vehicle occupant seated in a seat, other than the driver's seat, for example. The state detector 172 may detect one or both of a state of the vehicle occupant and a state of the seat 87. Note that the state detector 172 may detect the aforementioned states, when information on a changeover of driving modes input by the automated driving controller 120 indicates a transition from a driving mode (e.g., automated driving mode (Mode A) in which the vehicle occupant seated in the seat 87 of the driver's seat does not have a responsibility to monitor the surroundings of the vehicle M, to a driving mode (e.g., automated driving mode (Modes B and C), manual driving mode) in which the vehicle occupant has the responsibility to monitor the surroundings.

For example, the state detector 172 may analyze an image taken by the interior camera 91 or analyze sound information from the microphone 92 or the like, and detect a state of the vehicle occupant on the basis of the acquired result. Detectable states of the vehicle occupant include “asleep,” “awake,” “watching contents displayed on the display device 82,” and “talking with another occupant,” for example. However, the embodiment is not limited to these, and states such as “unconscious,” may also be detected. For example, the state detector 172 extracts a facial image from an image taken by the interior camera 91 on the basis of facial feature information (e.g., position, shape, color and the like of eyes, nose, mouth and other parts), and further acquires information such as open or closed states of the eyes and a sight line direction from the extracted facial image, to thereby acquire the aforementioned state of the vehicle occupant. Note that the state detector 172 may acquire a position of the face (a position in the interior space) and a direction of the face, for example, on the basis of the position and angle of view of the fixedly connected interior camera 91.

Additionally, the state detector 172 can acquire states such as the vehicle occupant's “snoring state,” and “talking state,” by analyzing character information from voice, or analyzing the intonation of sound, for example, which are acquired from the microphone 92. By using the analysis result of taken image and analysis result of sound mentioned above, the state of the vehicle occupant can be detected more accurately. For example, even if it is detected from image analysis that the eyes of the vehicle occupant are open, the state detector 172 can determine that the vehicle occupant is asleep if it is estimated from sound analysis that he/she is snoring.

Additionally, the state detector 172 may detect states continuously, to detect a sleeping time or time watching a content, for example. With this, the wakefulness controller 174 can perform wakefulness control according to the lengths of sleeping time and the time of watching a content.

In addition, the state detector 172 may detect a state of the seat 87 by the seat position detector 88A. Note that, while a reclining angle is one example of a state of the seat 87, states of the seat 87 may include a position in front, rear, upper, and lower directions and a yaw angle of the seat 87, and a tilt angle and a position in upper and lower directions of the headrest. Also, a state of the seat, may be used as a state of the vehicle occupant mentioned above.

In addition, the state detector 172 compares one or both of a state of the vehicle occupant and a state of the seat 87 with the wakefulness control information 188 stored in the storage 180, and sets a control content for waking the vehicle occupant. Also, when seat control is required, the state detector 172 outputs a control content to the seat controller 176 of the wakefulness controller 174, and when mist ejection is required, the state detector outputs a control content to the ejection controller 178 of the wakefulness controller 174. Note that the vehicle occupant on which to perform wakefulness control such as seat control and ejection control may be only the vehicle occupant seated in the driver's seat, or may include other vehicle occupants.

The seat controller 176 drives the seat driving device 88 according to the control content acquired from the state detector 172, and thereby drives the seat 87 on which the vehicle occupant or the like sits. For example, when the state detector 172 detects that the vehicle occupant seated in the seat 87 of the driver's seat is not in a wakeful state, the seat controller 176 may increase or decrease the reclining angle of the seat 87 in a stepwise manner. Additionally, when the state detector 172 detects that the vehicle occupant seated in the seat 87 of the driver's seat is not in a wakeful state, the seat controller 176 may make the change speed of reclining angle of the seat 87 faster than the change speed of reclining angle based on an instruction received by an operation receiver of the seat driving switch 86B or the like. Note that since the seat 87 can be driven electrically with a motor or the like, its speed is adjustable by adjusting the output torque of the motor. For example, a higher output torque increases the change speed of the reclining angle. Also, when the state detector 172 detects that the vehicle occupant seated in the seat 87 of the driver's seat is not in a wakeful state, the seat controller 176 may reciprocate the target seat 87 between a first direction that enables the vehicle occupant to monitor the surroundings of the vehicle M, and a second direction opposite to the first direction. Thus, it is possible to shake the vehicle occupant, for example, to prompt wakening, so that the vehicle occupant can be brought into a state where he/she can monitor the surroundings.

Additionally, the ejection controller 178 ejects a misty or vaporized liquid (e.g., mist) to a position of the face of the vehicle occupant from the ejection device 93, according to a control content acquired from the state detector 172. Note that the ejection amount, ejection direction, ejection time, and the like of the mist are preset in the control content from the state detector 172. By ejecting misty or vaporized liquid onto the vehicle occupant, it is possible to surprise the vehicle occupant, for example, and prompt wakening of the vehicle occupant. Hence, the vehicle occupant can be brought into a state where he/she can monitor the surroundings.

Note that the state detector 172 continues to detect states such as the state of the vehicle occupant after performing control by the wakefulness controller 174 (seat controller 176, ejection controller 178), and performs control on the seat 87 and the ejection device 93 on the basis of the detection result. Note that if the state of the vehicle occupant does not change to a wakeful state where he/she can monitor the surroundings, after performing the above-mentioned wakefulness control for not shorter than a predetermined time, for example, the state detector 172 may determine that the vehicle occupant is in an unconscious state (not capable of fulfilling surrounding-monitoring responsibility), and output information on this state (e.g., information preventing changeover of driving modes) or the like to the automated driving controller 120. In this case, the automated driving controller 120 may perform travel control such as letting the vehicle M travel without switching the driving mode, or temporarily stopping the vehicle M on the side of the road.

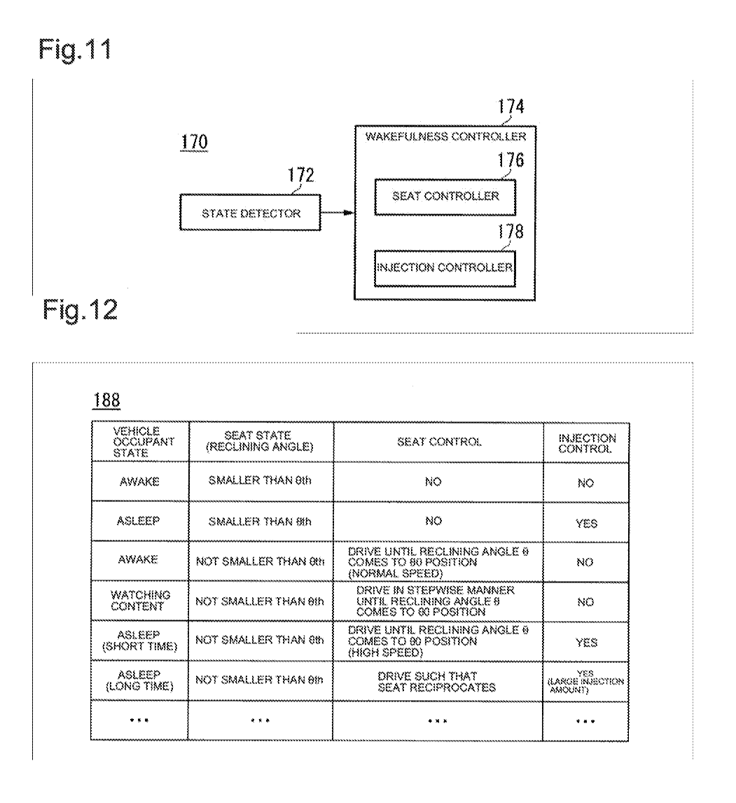

Here, FIG. 12 is a diagram showing an example of the wakefulness control information 188. Items of the wakefulness control information 188 shown in FIG. 12 include “vehicle occupant state,” “seat state (reclining angle),” “seat control,” and “ejection control,” for example. “Seat control” and “ejection control” are examples of wakefulness control for waking the vehicle occupant, and may also include sound control or the like of outputting sound, for example.

“Vehicle occupant state” is a state of the vehicle occupant, when changeover control of the driving mode of the vehicle M causes a transition, from a driving mode in which the vehicle occupant, does not have a responsibility to monitor the surroundings of the vehicle M, to a driving mode in which the vehicle occupant has the responsibility to monitor the surroundings. “Seat state (reclining angle)” is a state of the seat 87 of the driver's seat. The example of FIG. 12 sets information for determining whether a reclining angle θ detected by the seat position detector 88A is smaller, or not smaller than a predetermined angle θth. However, the information is not limited to this, and may include a state such as the yaw angle, for example.

“Seat control” sets, on the basis of a state of the vehicle occupant and a state of the seat 87, whether or not to control the seat 87, and the control content when controlling the seat. “Ejection control” sets, on the basis of a state of the vehicle occupant and a state of the seat 87, whether or not to perform control to eject a mist or the like onto the vehicle occupant by the ejection device 93, and the control content when ejecting the mist or the like.

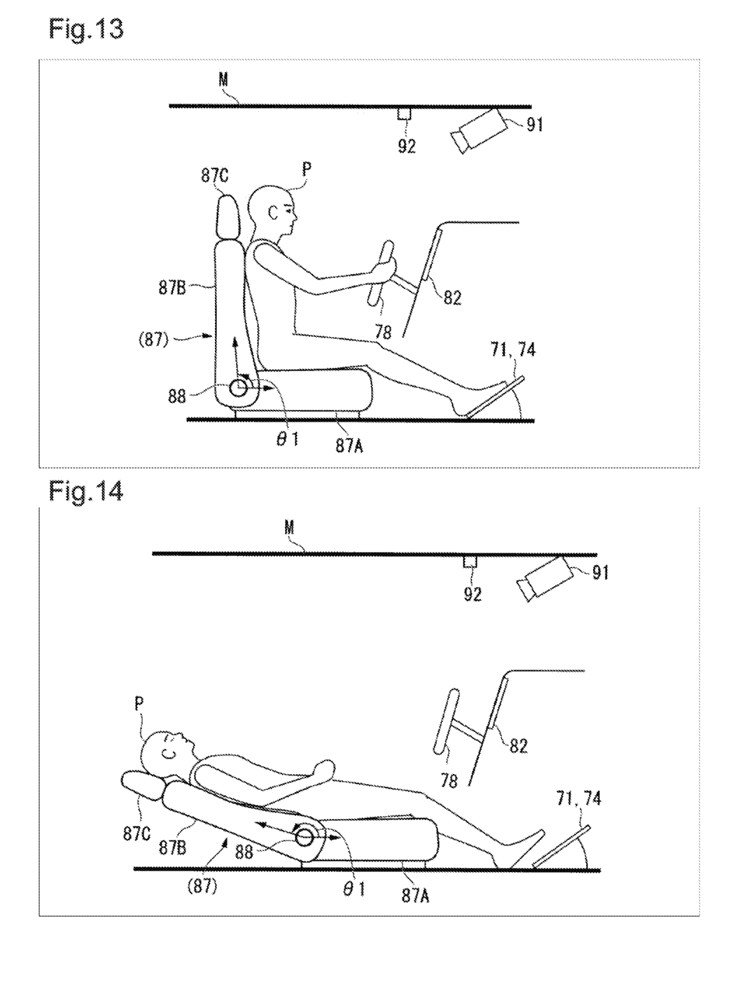

Next, contents of wakefulness control performed on the vehicle occupant based on the wakefulness control information 188 in FIG. 12 will be described with reference to the drawings. FIG. 13 is a diagram for describing a driving state of a vehicle occupant. The example in FIG. 13 shows a state where a vehicle occupant P of the vehicle M is seated in the seat 87 of the driver's seat. Also, in the example of FIG. 13, the display device 82, the seat 87, the interior camera 91, and the microphone 92 are shown as an example of the non-driving operation system of the HMI 70. Mote that the display device 82 indicates a display provided in the instrument panel. Additionally, installation positions of the interior camera 91 and the microphone 92 are not limited to the example of FIG. 13. Moreover, in the example of FIG. 13, the acceleration pedal 71 and the brake pedal 74 for manually controlling the speed of the vehicle M, and the steering wheel 78 for manually controlling steering of the vehicle M are shown as an example of the driving operation system of the HMI 70.

Also, the seat 87 shown in FIG. 13 includes a seat part (seat cushion) 87A, a seat back part (seat back) 87B, and a headrest 87C. The seat driving device 88 can detect an angle (reclining angle) between the seat part 87A and the seat back part 87B, for example, and can adjust the reclining angle. Note that in the example of FIG. 13, θ0 is a reclining angle in a driving position of the vehicle occupant that enables monitoring of the surroundings (e.g., enables manual driving).

FIG. 14 is a diagram for describing a state of the vehicle occupant inside the vehicle M, when he/she does not have a responsibility to monitor the surroundings. In the embodiment, when the vehicle M transitions to a mode, such as Mode A of the automated driving mode, where the vehicle occupant P in the driver's seat does not have a responsibility to monitor the surroundings, the vehicle occupant can recline the seat back part 87B and rest as in FIG. 14. The reclining angle in this case is larger than θ0. For example, the reclining angle is θ1 when the seat back part 87B is reclined as in FIG. 14. Note that since the vehicle occupant P in the driver's seat need not drive in the automated driving mode (e.g., Mode A), the vehicle occupant P in the driver's seat need not touch the steering wheel 78, the acceleration pedal 71, or the brake pedal 74, as in FIG. 14.

Here, the HMI controller 170 detects one or both of the state of the vehicle occupant P of the vehicle M and the state of the seat 87. Also, when a changeover of driving modes by the automated driving controller 120 causes a transition, from a driving mode (e.g., automated driving mode) in which the vehicle occupant P in the driver's seat does not have a responsibility to monitor the surroundings of the vehicle M, to a driving mode (e.g., manual driving mode) in which the vehicle occupant has the responsibility to monitor the surroundings, the HMI controller 170 drives the seat 87 by the seat driving device 88 on the basis of the state detection result described above.

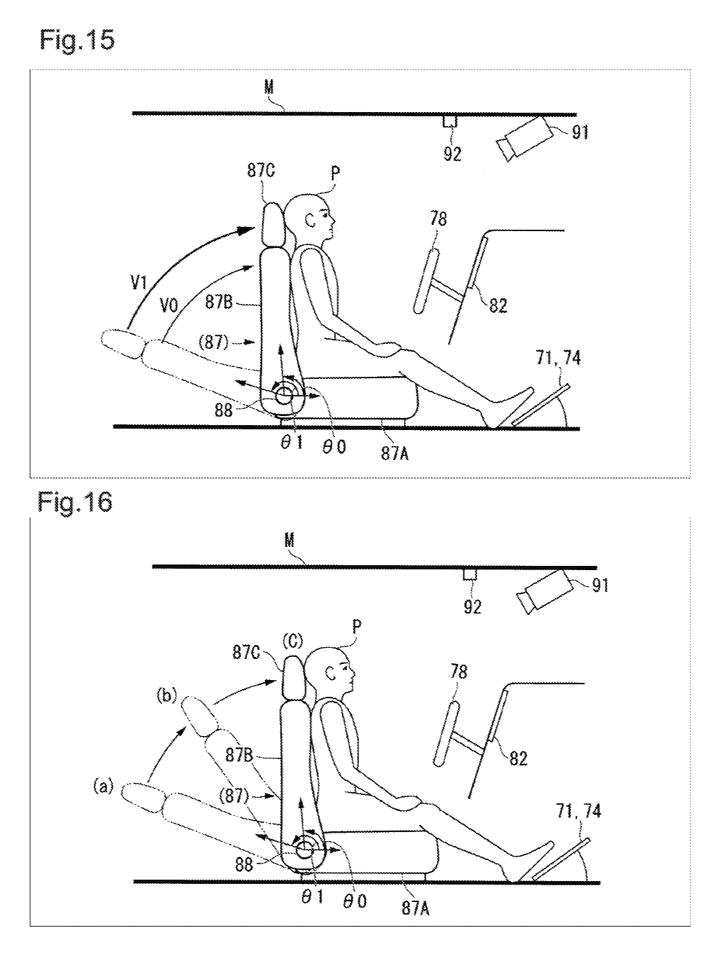

FIG. 15 is a diagram showing a first example of wakefulness control based on a state detection result. In the example of FIG. 15, assume that the vehicle occupant P in the driver's seat is “awake,” and the reclining angle θ of the seat 87 is θ1 (θ1>threshold angle θth). In this case, upon acquisition of the above contents as a state detection result, the state detector 172 acquires a wakefulness control content by referring to the wakefulness control information 188. According to the wakefulness control information 188, the wakefulness controller 174 drives the seat by the seat driving device 88 at a normal speed V0, until the reclining angle θ to the reclining angle θ0 position where manual driving is performed. Note that a normal speed is a drive speed of the seat driving device 88 when the vehicle occupant. P in the driver's seat, operates the seat driving switch 86B, for example. In the first example, since the vehicle occupant P in the driver's seat is awake and not concentrating on anything (e.g., watching a content), the reclining control at normal speed can notify the vehicle occupant P in the driver's seat of a changeover of driving modes, and let him/her prepare to monitor the surroundings.

Note that in the first example described above, if the vehicle occupant. P in the driver's seat, had been sleeping for only a short, time, the state detector 172 refers to the wakefulness control information 188, and drives the seat by the seat driving device 88 via the wakefulness controller 174 at a faster speed V1 of changing the reclining angle θ than the normal speed V0, until the reclining angle θ comes to the reclining angle θ0 position where manual driving is performed. Since the reclining of the seat 87 can thus raise the upper body of the vehicle occupant P in the driver's seat faster than at normal speed, it is possible to wake the vehicle occupant P and prompt wakefulness.

FIG. 16 is a diagram showing a second example of wakefulness control based on a state detection result. In the example of FIG. 16, assume that during a driving mode in which the vehicle occupant P in the driver's seat does not have a responsibility to monitor the surroundings, the vehicle occupant is “watching a content” with the seat 87 reclined at the reclining angle θ1 (θ1>threshold angle θth).

In this case, upon acquisition of the above contents as a state detection result, the state detector 172 acquires a wakefulness control content by referring to the wakefulness control information 188. According to the wakefulness control information 188, the wakefulness controller 174 drives the seat by the seat driving device 88 in a stepwise manner, until the reclining angle θ comes to the reclining angle θ0 position where manual driving is performed. Driving in a stepwise manner means to, during reclining control by the seat driving device 88, temporarily stop the seat back part 87B (and the headrest 87C) of the seat 87 at point (b) shown in FIG. 16 when moving it from positions (a) to (c) in FIG. 16, for example.

Note that in the second example, by providing multiple temporary stopping points, it is possible to notify the vehicle occupant P in the driver's seat by vibrating the seat back part 87B, for example. The HMI controller 170 can thus wake the vehicle occupant P in the driver's seat to a state where he/she can monitor the surroundings (or a state where the vehicle occupant P can drive the vehicle M manually). Also, in the second example, the reclining angle of the driver's seat may be increased or decreased in a stepwise manner to cause vibration.

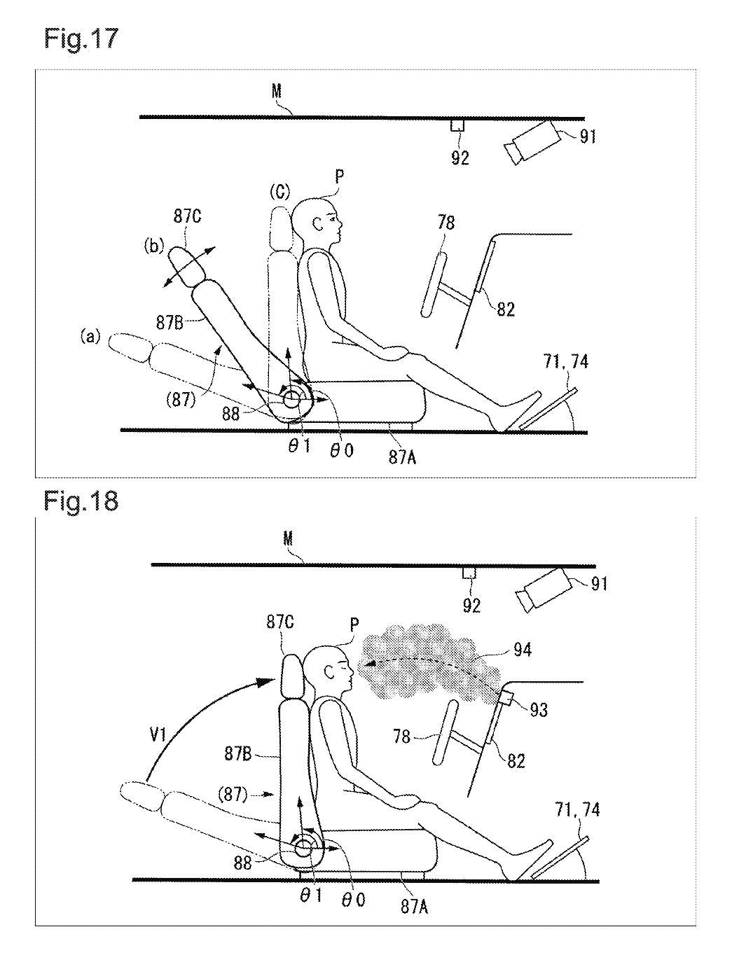

FIG. 17 is a diagram showing a third example of wakefulness control based on a state detection result. In the example of FIG. 17, assume that during a driving mode in which the vehicle occupant P in the driver's seat does not have a responsibility to monitor the surroundings, the vehicle occupant is “sleeping for a long time” with the seat 87 reclined at the reclining angle θ1 (θ1>threshold angle θth).

In this case, upon acquisition of the above contents as a state detection result, the state detector 172 acquires a wakefulness control content by referring to the wakefulness control information 188. According to the wakefulness control information 188, when the wakefulness controller 174 brings the reclining angle θ back to the reclining angle θ0 position by the seat driving device 88, the seat driving device 88 drives the seat back part. 87B of the seat 87 in a reciprocating manner.

In the third example, when moving the seat back part 87B (and headrest 87C) of the seat 87 from positions (a) to (c) in FIG. 17, in position (b) of FIG. 17, the wakefulness controller 174 drives the seatback part in a second direction ((a) direction) opposite to a first direction that moves it from positions (a) to (c). In this case, the driving in the second direction is continued until the reclining angle θ reaches a certain angle, or after the elapse of a certain time after moving in the second direction. Then, the wakefulness controller 174 drives the seat back part 87B of the seat 87 back in the first direction ((c) direction), and moves it to position (c). Note that the above-mentioned reciprocal motion of the seat back part 87B may be performed a predetermined number of times or more, and the speed of each reciprocal motion may be varied.

Since the HMI controller 170 can thus sway the upper body of the vehicle occupant P in the driver's seat, it is possible to effectively prompt wakening of the vehicle occupant P in the driver's seat to a state where he/she can monitor the surroundings, at the time of a changeover of driving modes.

FIG. 18 is a diagram showing a fourth example of wakefulness control based on a state detection result. In addition to the aforementioned seat driving device 88, the example of FIG. 18 shows an example of waking the vehicle occupant P in the driver's seat by ejection of a misty or vaporized liquid (e.g., mist) by the ejection device 93 installed in the vehicle M. Note that in the fourth example, the reclining angle θ of the seat 87 is not smaller than the threshold angle θth, and the vehicle occupant P in the driver's seat has been asleep for only a short time. Hence, the wakefulness controller 174 drives the seat by the seat driving device 88 at the speed V1 faster than the normal speed V0, until the reclining angle θ comes to the reclining angle θ0 position where manual driving is performed, and also ejects a mist 94 onto the face of the vehicle occupant P in the driver's seat by the ejection device 93.

As shown in the fourth example, by ejecting the mist 94 onto the face of the vehicle occupant P in the driver's seat, it is possible to more surely wake the vehicle occupant P in the driver's seat, and prompt wakefulness. Note that the mist 94 may be a liquid that has smell, such as perfume. For example, by ejecting liquid that has an alerting scent, or perfume having a scent that is a favorite (or least favorite) of the vehicle occupant in the driver's seat, it is possible to wake the vehicle occupant P in the driver's seat quickly.

Note that the mist ejection by the wakefulness controller 174 may be performed in conjunction with the drive control on the seat 87, or be performed independently. Also, the amount of mist to be ejected may be adjusted, depending on the state of the vehicle occupant and the state of the seat 87. These control items may be set in the wakefulness control information 188.

Additionally, when notified of driving mode information by the automated driving controller 120, the HMI controller 170 may refer to the mode-specific operability information 190, and control the HMI 70 according to the type of driving mode (manual driving mode, automated driving mode (Modes A to C)).

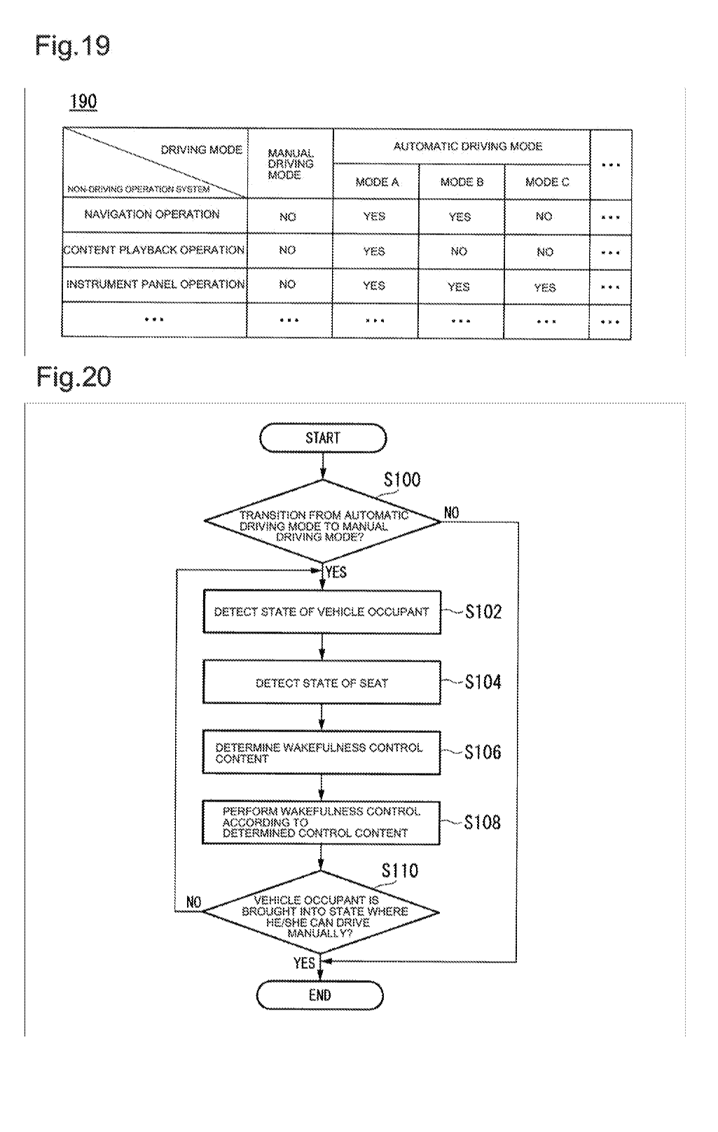

FIG. 19 is a diagram showing an example of the mode-specific operability information 190. The mode-specific operability information 190 shown in FIG. 19 has, as items of the driving mode, “manual driving mode” and “automated driving mode.” Also, “automated driving mode” includes the aforementioned “Mode A,” “Mode B,” and “Mode C,” for example. The mode-specific operability information 190 also has, as items of the non-driving operation system, “navigation operation” which is operation of the navigation device 50, “content playback operation” which is operation of the content playback device 85, and “instrument panel operation” which is operation of the display device 82, for example. While the example of the mode-specific operability information 190 in FIG. 19 sets the vehicle occupant's operability of the non-driving operation system for each of the aforementioned driving modes, the target interface device (e.g., output part) is not limited to these.

The HMI controller 170 refers to the mode-specific operability information 190 on the basis of mode information acquired from the automated driving controller 120, and thereby determines the operable and inoperable devices. Also, based on the determination result, the HMI controller 170 performs control to determine whether or not to receive the vehicle occupant's operation of the HMI 70 of the non-driving operation system or the navigation device 50.

For example, when the driving mode executed by the vehicle control system 100 is a manual driving mode, the vehicle occupant operates the driving operation system (e.g., acceleration pedal 71, brake pedal 74, shift, lever 76, and steering wheel 78) of the HMI 70. In this case, to prevent driver distraction, the HMI controller 170 performs control to not receive operation of part of or the entire non-driving operation, system of the HMI 70.

When the driving mode executed by the vehicle control system 100 is Mode B, Mode C or the like of the automated driving mode, the vehicle occupant has a responsibility to monitor the surroundings of the vehicle M. Hence in this case, too, the HMI controller 170 performs control to not receive operation of part of or the entire non-driving operation system of the HMI 70.

When the driving mode is Mode A of the automated driving mode, the HMI controller 170 eases the driver distraction restriction, and performs control to receive the vehicle occupant's operation of the non-driving operation system, which had been restricted.

For example, the HMI controller 170 displays an image by the display device 82, outputs sound by the speaker 83, and plays a content of a DVD or the like by the content playback device 85. Note that contents played by the content playback device 85 may include various contents related to recreation and entertainment, such as a television program, for example, in addition to contents stored in a DVD or the like. Also, “content playback operation” shown in FIG. 19 may indicate operation of such contents related to recreation and entertainment.

In addition, of the mode-specific operability information 190 shown in FIG. 19, “instrument panel operation” is enabled even in Mode C, Note that in this case, the display device 82 serving as the instrument panel is a display in front of the vehicle occupant (driver) seated in the driver's seat, for example. Hence, the display device 82 can receive the vehicle occupant's operation, when executing a mode having the lowest degree of automated driving among the automated driving modes (Modes A to C).

[Processing Flow]

Hereinafter, wakefulness control processing of the vehicle control system 100 of the embodiment will be described by use of a flowchart. Note that although the following describes wakefulness control processing of the vehicle occupant in the driver's seat during handover control of transitioning from automated driving mode (a driving mode in which the vehicle occupant in the driver's seat does not have a responsibility to monitor the surroundings of the vehicle M) to manual driving mode (a driving mode in which the vehicle occupant in the driver's seat has the responsibility to monitor the surroundings of the vehicle M), near a scheduled end point or the like of an automated driving mode set in the behavior plan information 186 or the like, the condition of performing wakefulness control processing is not limited to the above-mentioned changeover of driving modes.

FIG. 20 is a flowchart showing an example of wakefulness control processing. In the example of FIG. 20, the state detector 172 determines whether or not the vehicle M is to transition from automated driving mode to manual driving mode, on the basis of driving mode changeover information or the like acquired from the automated driving controller 120 (Step S100). If it is determined that the vehicle M is to transition from automated driving mode to manual driving mode, the state detector 172 detects a state of the vehicle occupant of the vehicle M (Step S102), and detects a state of the seat 87 (Step S104).

Next, the state detector 172 refers to the aforementioned wakefulness control information 188 or the like on the basis of one or both of the aforementioned state of the vehicle occupant in the driver's seat and state of the seat 87, and determines the corresponding control content (Step S106). Next, the wakefulness controller 174 performs wakefulness control according to the determined control content (Step S108).

Here, the state detector 172 determines whether or not the vehicle occupant in the driver's seat is brought into a state where he/she can drive manually (awakened) (Step S110). A state where the vehicle occupant in the driver's seat can drive manually is a state where he/she can monitor the surroundings of the vehicle M, and can drive manually by operating the driving operation system of the HMI 70. Also, a state where the vehicle occupant can monitor the surroundings of the vehicle M is a state where the vehicle occupant in the driver's seat is awake, and the reclining angle θ of the seat 87 is not larger than the threshold angle θth, for example.

If the vehicle occupant is not brought into a state where he/she can drive manually, the processing returns to S102, and wakefulness control is performed according to the current states of the vehicle occupant in the driver's seat and/or the seat. With this, if the vehicle occupant is still asleep after raising the seat hack part 87B of the seat 87, for example, it is possible to perform another kind of wakefulness control such as ejecting a mist onto the face of the vehicle occupant. Additionally, if the vehicle occupant is not brought into a state where he/she can drive manually in the processing of step S108, the vehicle occupant may be unconscious. Hence, the state detector 172 can stop the repeat processing, and perform control to prevent transitioning to manual driving mode. Meanwhile, if the vehicle occupant is brought into a state where he/she can drive manually, the wakefulness control processing is terminated, and mode changeover control (e.g., handover control) is performed. Note that although both of the state of the vehicle occupant and the state of the seat have been detected in the processing of FIG. 20, the embodiment is not limited to this. Instead, the processing may be configured to detect only one of the state of the vehicle occupant and the state of the seat, for example.

According to the embodiment described above, it is possible to bring the vehicle occupant of the vehicle M into a state where he/she can monitor the surroundings (wake) at the time of a changeover of drive modes, by detecting one or both of a state of the vehicle occupant and a state of the seat, and controlling the position or behavior of the seat according to the detection result. Additionally, according to the embodiment, it is possible to more surely wake the vehicle occupant, by ejecting a misty or vaporized liquid onto the vehicle occupant according to the detect ion result. Note that the awakening target is not limited to the vehicle occupant in the driver's seat, and may include vehicle occupants seated in the seats 87 other than the driver's seat, of the vehicle M, for example.

Although forms of implementing the present invention have been described by use of embodiments, the invention is not limited in any way to these embodiments, and various modifications and replacements can be made without departing from the gist, of the present invention.

### DESCRIPTION OF REFERENCE NUMERALS

20 . . . finder, 30 . . . radar, 40 . . . camera, DD . . . detection device, 50 . . . navigation device, 60 . . . vehicle sensor, 70 . . . HMI, 100 . . . vehicle control system, 110 . . . target, lane determination part, 120 . . . automated driving controller (driving controller), 130 . . . automated driving mode controller, 140 . . . vehicle position recognition part, 142 . . . surrounding recognition part, 144 . . . behavior plan generation part, 146 . . . trajectory generation part, 146A . . . traveling mode determination part, 146B . . . trajectory candidate generation part, 146C . . . evaluation and selection part, 150 . . . changeover controller, 160 . . . travel controller, 170 . . . HMI controller (interface controller), 172 . . . state detector, 174 . . . wakefulness controller, 176 . . . seat, controller, 178 . . . ejection controller, 180 . . . storage, 200 . . . driving force output device, 210 . . . steering device, 220 . . . brake device, M . . . vehicle

1. A vehicle control system comprising:
a driving controller configured to perform one of a plurality of driving modes having different degrees of requirements for automated driving, to control any one of
automated driving in which at least one of speed control and steering control of a vehicle is performed automatically, and
manual driving in which both of speed control and steering control of said vehicle are performed according to operations by a driver of said vehicle;
a driver's seat installed in said vehicle and configured to be electrically drivable;
a state detector configured to detect a state of the driver seated in said driver's seat, thereby to detect whether or not the driver is in a wakeful state; and
a seat controller configured to be able to drive said driver's seat if said state detector detects that the driver is not in a wakeful state, wherein
said plurality of driving modes comprise a first driving mode in which the driver is not required to monitor surroundings of said vehicle and a second driving mode in which the driver is required to monitor the surroundings, and
the seat controller drives said driver's seat when said state detector detects that the driver is not in a wakeful state and the driving mode is changed from the first driving mode to the second driving mode.

2. The vehicle control system according to claim 1, wherein
said seat controller increases or decreases a reclining angle of said driver's seat in a stepwise manner, when said state detector detects that the driver seated in said driver's seat is not in a wakeful state and the driving mode is changed from the first driving mode to the second driving mode.

3. The vehicle control system according to claim 2, further comprising an operation receiver configured to receive an operation by said driver to preset a speed of changing the reclining angle of said driver's seat, wherein
said seat controller drives said driver's seat at a speed which is faster than the preset speed of changing the reclining angle of said driver's seat, when said state detector detects that the driver seated in said driver's seat is not in a wakeful state and the driving mode is changed from the first driving mode to the second driving mode.

4. The vehicle control system according to claim 1, wherein
said seat controller drives said driver's seat, in a manner that reciprocates said driver's seat between a first direction that enables said driver to monitor the surroundings of said vehicle and a second direction opposite to said first direction, when said state detector detects that the driver seated in said driver's seat is not in a wakeful state and the driving mode is changed from the first driving mode to the second driving mode.

5. The vehicle control system according to claim 1, further comprising:
an ejection device configured to eject misty or vaporised liquid; and
an election controller configured to eject said misty or vaporized liquid toward said driver from said ejection device, when the driving mode is changed from the first driving mode to the second driving mode.

6. A vehicle control method performed by an onboard computer, comprising:
preforming one of a plurality of driving modes having different degrees of automated driving, to control any one of
automated driving in which at least one of speed control and steering control of a vehicle is performed automatically, and
manual driving in which both of speed control and steering control of said vehicle are performed according to operations by a driver of said vehicle, in which said plurality of driving modes comprise a first driving mode in which the driver is not required to monitor surroundings of said vehicle and a second driving mode in which the driver is required to monitor the surroundings;
detecting a state of the driver seated in an electrically drivable driver's seat of said vehicle, thereby to detect whether or not the driver is in a wakeful state; and
driving said driver's seat when it is detected that the driver seated in said driver's seat is not in a wakeful state and the driving mode is changed from the first driving mode to the second driving mode.

7. A vehicle control program executable by an onboard computer, comprising instructions to:
perform one of a plurality of driving modes having different degrees of automated driving, to control any one of
automated driving in which at least one of speed control and steering control of a vehicle is performed automatically, and
manual driving in which both of speed control and steering control of said vehicle are performed according to operations by a driver of said vehicle, in which said plurality of driving modes comprise a first driving mode in which the driver is not required to monitor surroundings of said vehicle and a second driving mode in which the driver is required to monitor the surroundings;
detect a state of the driver seated in an electrically drivable driver's seat of said vehicle, thereby to detect whether or not the driver is in a wakeful state; and
drive said driver's seat when it is detected that the driver seated in said driver's seat is not in a wakeful state and the driving mode is changed from the first driving mode to the second driving mode.
